(19) United States
(12) Patent Application Publication
(10) Pub. No.: US 2013/0239693 A1
(43) Pub. Date: Sep. 19, 2013

(54) ROBOT

(71) Applicant: CHAO-QIANG LIU, Shenzhen City (CN)

(72) Inventor: CHAO-QIANG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/592,696

(22) Filed: Aug. 23, 2012

(30) Foreign Application Priority Data
Mar. 16, 2012 (CN) 201210070026.4

(51) Int. Cl. G01L 7/00

(52) U.S. Cl. 73/706

(57) ABSTRACT

A robot includes a mounting base, an arm body, a pressure measuring assembly and a protective cover. The arm body is rotatably connected with the mounting base. The pressure measuring assembly is positioned on an outer surface of the mounting base. The protective cover is mounted on the outer surface of the mounting base and covers the pressure measuring assembly. The protective cover includes a base body, a first sidewall and a second sidewall. The base body defines an observation window to observe the pressure readout values from the pressure measuring assembly. The first sidewall and the second sidewall extend from opposite ends of the base body; the first sidewall and the second sidewall are positioned on the mounting base. The base body, the first sidewall and the second sidewall form a receiving space to receive the pressure measuring assembly.

### BACKGROUND

1. Technical Field

This disclosure relates to robots, and particularly, to a robot with a protective cover for operating under harsh environments.

2. Description of Related Art

Robots are used in harsh environments, such as in high temperatures, high gas pressures, and corrosive environments, to do dangerous and hazardous work. Because of having limited amount of room inside the robots, some elements, for example a pressure gauge or sensor, must be fixed to an outer sidewall of a housing of the robots. However, these elements are very vulnerable for becoming potentially damaged during the operations of the robot.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows a side view of an embodiment of a robot.

FIG. 2 shows an isometric view of the robot of FIG. 1.

FIG. 3 shows a partial, exploded isometric view of the robot of FIG. 2.

### DETAILED DESCRIPTION

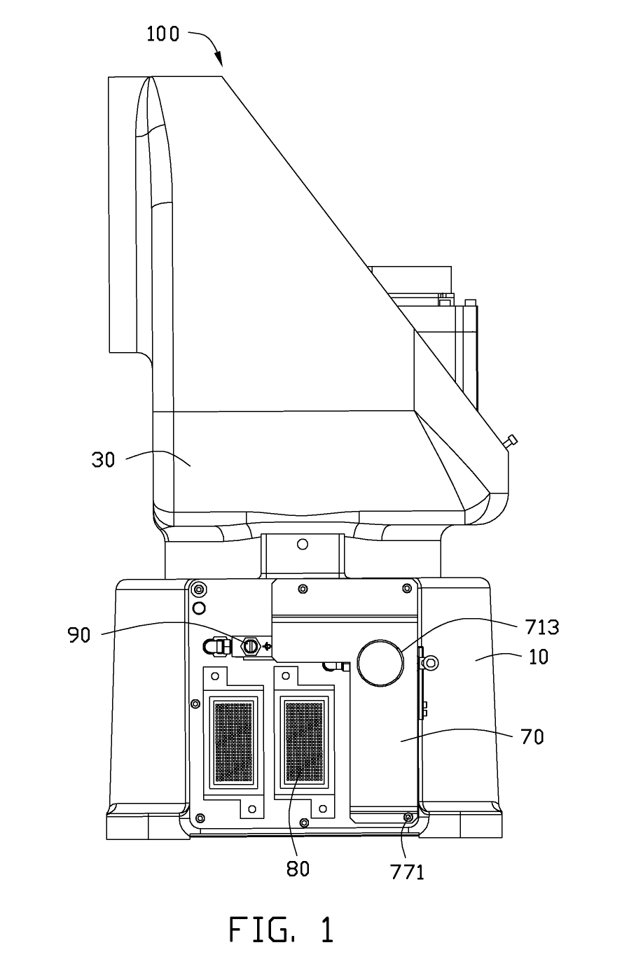

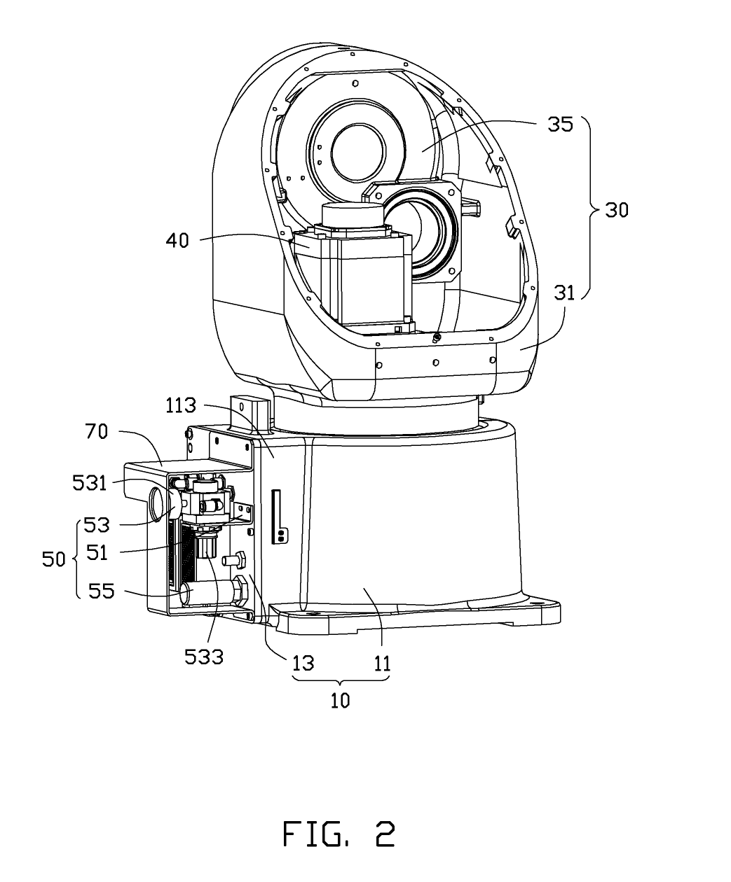

FIGS. 1 and 2 shows an embodiment of a robot 100. The robot 100 includes a mounting base 10, an arm body 30, a driver 40, a pressure measuring assembly 50, a protective cover 70, two explosion-proof SIBAS connectors 80 and a speed control valve 90. The arm body 30 is rotatably positioned on the mounting base 10. The driver 40 is received in the arm body 30 for driving the arm body 30 to rotate relative to the mounting base 10. The pressure measuring assembly 50, the protective cover 70, the explosion-proof SIBAS connectors 80 and the speed control valve 90 are positioned on an outer surface of the mounting base 10. The pressure measuring assembly 50 is used for monitoring gas pressure of the inside of the mounting base 10. The protective cover 70 shields and covers the pressure measuring assembly 50 to protect the pressure measuring assembly 50 from collisions and intrusions from the external environment. In the illustrated embodiment, the robot 100 is an explosion-proof robot, other functional components, such as a robot arm body (not shown) connected with the arm body 30, and other sensing or protective devices are not described here.

The mounting base 10 is substantially a hollow cone structure for positioning the robot 100 on a floor or another surface. The mounting base 10 includes a main body 11 and an installation board 13 positioned on the main body 11. The main body 11 includes a mounting portion 113 formed at one side of the main body 11. The mounting portion 113 is substantially rectangular and defines an opening 1131. The installation board 13 hermetically seals the opening 1131.

The arm body 30 includes a rotating portion 31 and a connecting portion 35. The rotating portion 31 is rotatably connected with the mounting base 10. The connecting portion 35 is positioned at one side of the rotating portion 31 for connecting with other robot arm body or other functional components.

The driver 40 is positioned in the rotating portion 31 for driving the arm body 30 to rotate relative to the mounting base 10.

The pressure measuring assembly 50 is mounted on the installation board 13 and exposed out of the mounting base 10. The pressure measuring assembly 50 includes a support member 51, a pressure gauge 53 and a silencer 55. The support member 51 is substantially perpendicularly connected with the installation board 13 for supporting the pressure gauge 53. The pressure gauge 53 is mounted on the support member 51. The pressure gauge 53 communicates with the internal portion of the mounting base 10 via a pipe (not shown) for monitoring and adjusting the internal gas pressure of the mounting base 10. The pressure gauge 53 includes a dial 531 for displaying the values of the gas pressure and an adjusting switch 533 connected with the dial 531. The adjusting switch 533 is capable of adjusting gas pressure of the mounting base 10. The silencer 55 is positioned on the installation board 13 adjacent to the adjusting switch 533 and the bottom of the mounting base 10 for eliminating some of the noise produced by the robot 100 during work.

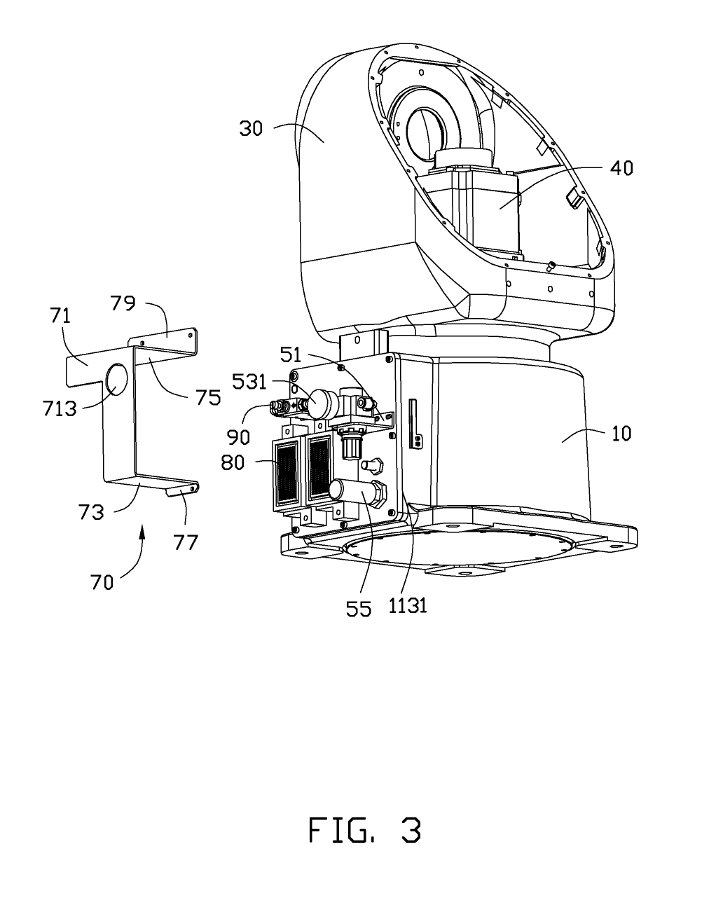

Also referring to FIG. 3, the protective cover 70 is detachably positioned on the installation board 13 and covers the pressure measuring assembly 50. In the illustrated embodiment, the protective cover 70 includes a base body 71, a first sidewall 73, a second sidewall 75, a first fixing portion 77 and a second fixing portion 79. The base body 71 is substantially an “L”-shaped board and is parallel to the installation board 13. A circular observation window 713 is defined at the base body 71 corresponding to the dial 531 for a user to observe the readout values displayed on the dial 531.

The first sidewall 73 and the second sidewall 75 perpendicularly extend from opposite ends of the base body 71, respectively. The first sidewall 73 is formed at a narrower end of the base body 71. The base body 71, the first sidewall 73 and the second sidewall 75 form a receiving space (not shown) to receive the pressure measuring assembly 50. The first fixing portion 77 perpendicularly extends from one edge of the first sidewall 73 away from the base body 71. The second fixing portion 79 perpendicularly extends from one edge of the second sidewall 75 away from the base body 71. The first, second fixing portions 77, 79 are fixedly positioned on the installation board 13 via a plurality of fasteners 771 (see FIG. 1). In other embodiments, the shape of the protective cover 70 is designed according to actual application intended needs. In other embodiments, the first sidewall 73 and the second sidewall 75 can be omitted, and then the first fixing portion 77 and the second fixing portion 79 are fixed to the installation board 13.

Two explosion-proof SIBAS connectors 80 are installed on the installation board 13 adjacent to the pressure measuring assembly 50 and spaced from each other. The explosion-proof SIBAS connectors 80 are made of carbon-free materials with excellent thermal conductivity, such as copper alloy, or stainless steel. Heat will be generated when the robot 100 suffers from an external hit, a plurality of impacts and explosions. The explosion-proof SIBAS connectors 80 are capable of simultaneously absorbing heat. The speed control valve 90 is mounted on the installation board 13 and positioned between the two explosion-proof SIBAS connector 80 for controlling the inflow or outflow of gas in the mounting base 10. In other embodiments, the number of explosion-proof connectors or SIBAS connectors may be one or three or more.

In the robot 100, the arm body 30 is rotatably positioned on the mounting base 10, the driver 40 is mounted in the rotating portion 31. The (explosion-proof) pressure measuring assembly 50, the explosion-proof SIBAS connectors 80, the speed control valve 90 are all assembled with the installation board 13. Finally, the protective cover 70 is mounted on the installation board 13 and covers the (explosion-proofed) pressure measuring assembly 50.

The base body 71, the first sidewall 73 and the second sidewall 75 of the protective cover 70 form the receiving space to receive the explosion-proof pressure measuring assembly 50. The protective cover 70 completely shields the explosion-proof pressure measuring assembly 50 from collisions and impacts generated from external environment and insulate the pressure measuring assembly 50 against any corrosive agents in the external environment where the robot 100 is operating within. Users can observe the values displayed on the dial 531 via the observation window 713 to monitor the gas pressure of the mounting base 10. The speed control valve 90 can be adjusted from the sides of the protective cover 70. The protective cover 70 does not hinder or prevent the convenient use of the pressure measuring assembly 50.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot comprising:
a mounting base;
an arm body rotatably connected with the mounting base;
a pressure measuring assembly positioned on an outer surface of the mounting base; and
a protective cover mounted on the outer surface of the mounting base and covering the pressure measuring assembly, comprising:
a base body defining an observation window thereon, the observation window allowing a user to observe one or more pressure readout values from the pressure measuring assembly;
a first sidewall and a second sidewall extending from opposite ends of the base body, respectively, the first sidewall and the second sidewall positioned on the mounting base, wherein the base body, the first sidewall and the second sidewall cooperatively form a receiving space to receive the pressure measuring assembly.

2. The robot of claim 1, wherein the protective cover further comprises a first fixing portion and a second fixing portion, the first fixing portion extends from one edge of the first sidewall away and deviating from the base body, the second fixing portion extends from one edge of the second sidewall away and deviating from the base body, the first fixing portion and the second fixing portion are fixed to the mounting base.

3. The robot of claim 1, wherein the mounting base comprises a main body and an installation board, the main body forms a mounting portion, the installation board covers the mounting portion; the pressure measuring assembly is positioned on the installation board.

4. The robot of claim 3, wherein the base body is parallel to the installation board.

5. The robot of claim 1, wherein the pressure measuring assembly comprises a pressure gauge connected and communicating with the mounting base, the observation window is positioned corresponding to the pressure gauge.

6. The robot of claim 5, wherein the pressure gauge comprises a dial facing toward the observation window.

7. The robot of claim 6, wherein the pressure gauge further comprises an adjusting switch connected with the dial.

8. The robot of claim 5, further comprising a support member mounting on the mounting base, the pressure gauge is positioned on the support member.

9. The robot of claim 5, wherein the pressure measuring assembly further comprises a silencer, the silencer is positioned on the installation board adjacent to the pressure gauge.

10. The robot of claim 1, wherein the robot further comprises at least one explosion-proof SIBAS connector positioned adjacent to the protective cover.

11. The robot of claim 1, wherein the robot further comprises a speed control valve positioned on the mounting base adjacent to the protective cover.
